(19) United States
(12) Patent Application Publication
(10) Pub. No.: US 2023/0388218 A1
(43) Pub. Date: Nov. 30, 2023

(54) Administering Network-Connected Devices Using Tunneled Routing

(71) Applicant: Google LLC, Mountain View, CA (US)

(72) Inventors: Grant Michael Erickson, Los Altos Hills, CA (US); Jay Dare Logue, San Jose, CA (US)

(73) Assignee: Google LLC, Mountain View, CA (US)

(21) Appl. No.: 18/027,333

(22) PCT Filed: Sep. 22, 2020
(86) PCT No.: PCT/US2020/051915

§ 371 Date: Mar. 20, 2023

(51) Int. Cl. H04L 45/02

(52) U.S. Cl. CPC H04L 45/04

(57) ABSTRACT

Techniques and devices for administering network-connected devices using tunneled routing are described for accessing administrative services using an access router in a network segment of a fabric network in which a first access router in a first network segment of a fabric network receives a first advertisement for a second network segment of the fabric network and establishes a first secure tunnel with a second access router in the second network segment in the fabric network. The first access router advertises, in the first network segment, a first network route to an Ecosystem Administrative Service, EAS, in the second network segment, and uses the advertised first network route to route messages between one or more devices in the first network segment and the EAS.

### BACKGROUND

Using wireless networking to connect devices to each other, and to cloud-based services, is increasingly popular for sensing environmental conditions, controlling equipment, and providing information and alerts to users. Many devices on wireless networks are designed to operate in a network environment provided and managed by an ecosystem provider. The devices in the network environment may be provided exclusively by the ecosystem provider or devices from third-party vendors may be included to expand the functionality provided to end users.

Within the network environment, devices that are provided by the ecosystem operate and are maintained (e.g., software upgrading, diagnostics, or the like) using services provided by the ecosystem provider. While devices from third-party vendors operate with services provided by the ecosystem provider, third-party vendors continue to provide administration and maintenance for their devices using their services that may not operate using services supported by the ecosystem provider. However, there are opportunities to provide access to both ecosystem and third-party devices in a uniform manner to support administration and maintenance of devices in wireless or wired networks.

### SUMMARY

This summary is provided to introduce simplified concepts of administering network-connected devices using tunneled routing, generally related to securely accessing administrative services using an access router in a fabric network. The simplified concepts are further described below in the Detailed Description. This summary is not intended to identify essential features of the claimed subject matter, nor is it intended for use in determining the scope of the claimed subject matter.

In aspects, methods, devices, systems, and means for administering network-connected devices using tunneled routing are described for accessing administrative services using an access router in a network segment of a fabric network. A first access router in a first network segment of a fabric network receives a first advertisement for a second network segment of the fabric network and establishes a first secure tunnel with a second access router in the second network segment in the fabric network. The first access router advertises in the first network segment a first network route to an Ecosystem Administrative Service (EAS) in the second network segment and uses the advertised first network route to route messages between one or more devices in the first network segment and the EAS. The first access router in the first network segment of the fabric network receives a second advertisement for a fourth network segment of the fabric network and establishes a second secure tunnel with a third access router in the fourth network segment. The first access router advertises in the first network segment a second network route to the Vendor Administrative Service (VAS) in the fourth network segment and uses the advertised second network route to route messages between one or more devices in the first network segment and the VAS.

The details of one or more implementations are set forth in the accompanying drawings and the following description. Other features and advantages will be apparent from the description and drawings and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

Aspects of administering network-connected devices using tunneled routing are described with reference to the following drawings. The same numbers are used throughout the drawings to reference like features and components:

FIG. 1 illustrates an example network environment in which various aspects of administering network-connected devices using tunneled routing can be implemented.

FIG. 2 illustrates an example environment in which various aspects of administering network-connected devices using tunneled routing can be implemented.

FIG. 3 illustrates an example fabric network with which aspects of administering network-connected devices using tunneled routing can be implemented.

FIG. 4 illustrates example message routing between a device and an in-premises EAS in accordance aspects of administering network-connected devices using tunneled routing.

FIG. 5 illustrates example message routing between a device and an in-premises EAS in accordance aspects of administering network-connected devices using tunneled routing.

FIG. 6 illustrates example message routing between a device and an out-of-premises EAS in accordance aspects of administering network-connected devices using tunneled routing.

FIG. 7 illustrates example message routing between a device and an out-of-premises EAS in accordance aspects of administering network-connected devices using tunneled routing.

FIG. 8 illustrates example message routing between a device and a VAS in accordance aspects of administering network-connected devices using tunneled routing.

FIG. 9 illustrates example message routing between a device and a VAS in accordance aspects of administering network-connected devices using tunneled routing.

FIG. 10 illustrates example message routing between a device and a VAS in accordance aspects of administering network-connected devices using tunneled routing.

FIG. 11 illustrates example message routing between a device and a VAS in accordance aspects of administering network-connected devices using tunneled routing.

FIG. 12 illustrates example message routing between a device and a VAS in accordance aspects of administering network-connected devices using tunneled routing.

FIG. 13 illustrates example message routing between a device and a VAS in accordance aspects of administering network-connected devices using tunneled routing.

FIG. 14 illustrates an example method of securely accessing administrative services using an access router in a network segment of a fabric network in accordance with aspects of the techniques described herein.

FIG. 15 illustrates an example environment in which aspects of the techniques described herein can be implemented.

FIG. 16 illustrates an example wireless network device that can be implemented in a home area network in accordance with one or more aspects of the techniques described herein.

FIG. 17 illustrates an example system with an example device that can implement aspects of administering network-connected devices using tunneled routing.

### DETAILED DESCRIPTION

This document describes techniques and devices to accommodate vendor-specific administrative services in an Internet of Things (IoT) environment, for example, in a residential or commercial building automation system (e.g., an automation system deployed using a Weave network, a fabric network, or a Connected Home over IP (CHIP) network). Many times, in IoT systems, a primary service provider or vendor provides many of the deployed IoT devices in the system as well as overall administrative and operational services for a deployed system. However, in many systems, devices from third-party vendors may be deployed to enhance system functionality. While the third-party devices operate under the administrative and operational services of the primary vendor, third-party vendors may not want to be disintermediated from the end customers of their devices and may want to provide critical interactions with those devices in the form of diagnostics, maintenance, software updates and/or support.

The overall administrative and operational services for an IoT deployment are managed by an Ecosystem Administrative Service (EAS) operated by the primary service provider or vendor. The EAS can be an out-of-premises EAS deployed as a cloud-based service, or the EAS can be an in-premises, device-based EAS. Whether in-premises or out-of-premises, the EAS provides services including software updates, file downloads, time of day and time synchronization, file uploads, vending of operational certificates for authentication, device and resource directories or registries, data management proxies (e.g., for commands, state, and/or settings), or the like.

The EAS provides a singular architecture and mechanism for interacting with the EAS regardless of whether the EAS is an in-premises EAS or an out-of-premises EAS, and regardless of the type of network link (e.g., Wi-Fi, Ethernet, Thread) used by an IoT device. The EAS architecture also supports seamlessly and dynamically managing the transition of the EAS (or portions thereof) into and out of the premises, for example, between a cloud-based EAS and an in-premises EAS resident on a hub device.

An auxiliary Vendor Administrative Service (VAS) of a third-party vendor provides out-of-premises services (for third-party devices) that are similar to those provided by an EAS. For example, a VAS may provide software updates, file downloads (in support of software updates), file uploads (in support of crash dumps, unstructured logs, support reports, or the like), data management proxies (e.g., for commands, state, and/or settings), such as proxies in support of structured event reporting and logging, configuration/settings changes diagnostic and support commands (e.g., “dump/upload events and logs”), or the like.

### Example Environment

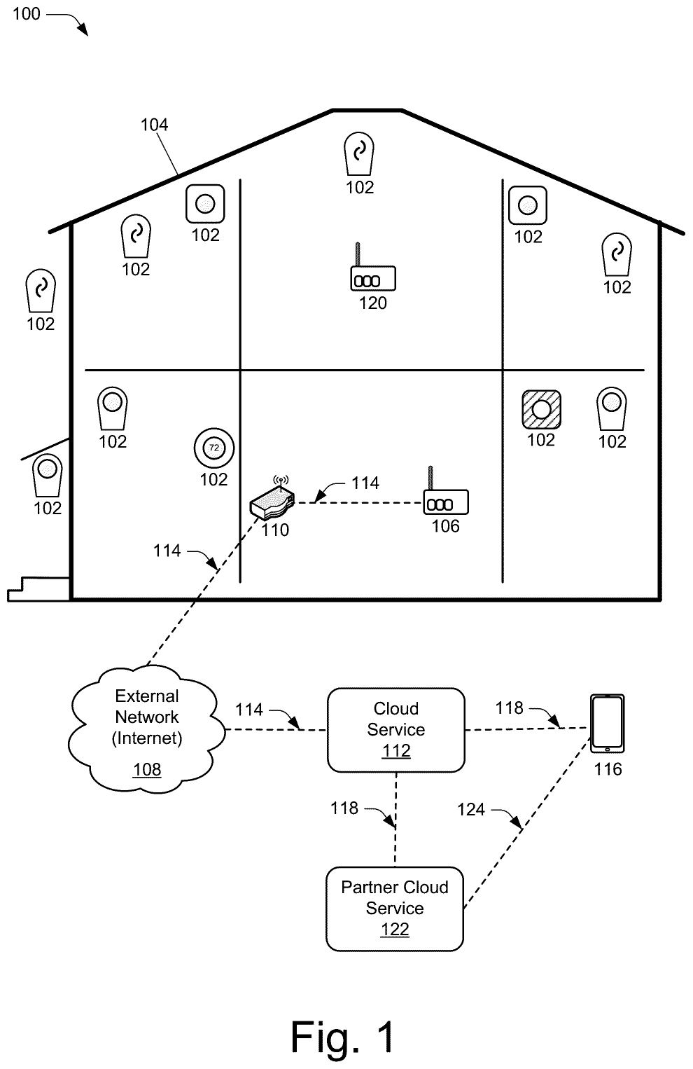

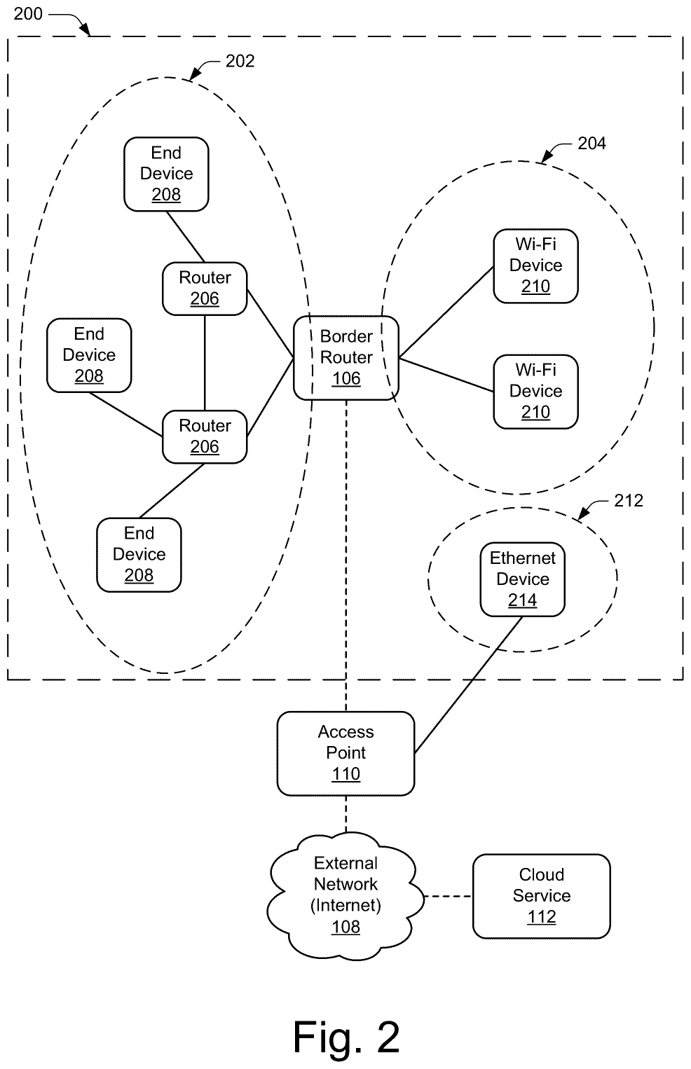

FIG. 1 illustrates an example network environment 100 in which aspects of administering network-connected devices using tunneled routing can be implemented. The network environment 100 (e.g., a fabric network, a CHIP fabric network, a Weave network) includes one or more network segments (subnets) that form a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108 (access network 108), such as the Internet, through a home router or access point 110.

To provide user access to functions implemented using the wireless network devices 102 in the HAN, a cloud service 112 connects to the HAN via border router 106, via a secure tunnel 114 through the external network 108 (access network 108) and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers which orchestrate and arbitrate home automation experiences, as described in greater detail below. The cloud service 112 may also include an out-of-premises EAS.

The HAN may include one or more wireless network devices 102 that function as a hub 120. The hub 120 may be a general-purpose home automation hub, or an application-specific hub, such as a security hub, an energy management hub, an HVAC hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102. For example, the hub 120 (or the border router 106) may host an in-premises EAS or portions of the services provided by an EAS.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114. The partner cloud services 122 may include a VAS for support of the partner's devices.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example environment (e.g., a fabric network, a Weave network, a CHIP fabric network) in which various aspects of administering network-connected devices using tunneled routing can be implemented. The home area network (HAN) 200 includes a wireless mesh network segment 202 (e.g., a Thread network segment), a Wi-Fi network segment 204, and/or an Ethernet segment 212. The wireless mesh network segment 202 includes routers 206 and end devices 208. The routers 206 and the end devices 208, each include a mesh network interface for communication over the mesh network segment 202. The routers 206 receive and transmit packet data over the mesh network interface. The routers 206 also route traffic across the mesh network segment 202. The end devices 208 are devices that can communicate using the mesh network segment 202, but lack the capability, beyond simply forwarding to its parent router 206, to route traffic in the mesh network segment 202. For example, a battery-powered sensor is one type of end device 208. The Wi-Fi network segment 204 includes Wi-Fi devices 210. Each Wi-Fi device 210 includes a Wi-Fi network interface for communication over the Wi-Fi network segment 204. Optionally or additionally, the HAN 200 can include an Ethernet network segment 212 that includes one or more Ethernet devices 214 that connect to the border router 106 or the access point 110.

The border router 106 is included in the wireless mesh network segment 202 and is included in the Wi-Fi network segment 204. The border router 106 includes a mesh network interface for communication over the mesh network segment 202 and a Wi-Fi network interface for communication over the Wi-Fi network segment 204. The border router 106 routes packets between devices in the wireless mesh network segment 202 and the Wi-Fi network segment 204. The border router 106 also routes packets between devices in the HAN 200 and external network nodes (e.g., the cloud service 112) via the access network 108, such as the Internet, through a home router or access point 110.

The devices in the mesh network segment 202, the Wi-Fi network segment 204, and the Ethernet network segment 212 use standard IP routing configurations to communicate with each other through transport protocols such as the User Datagram Protocol (UDP) or the Transmission Control Protocol (TCP). When the devices in the mesh network segment 202, the Wi-Fi network segment 204 and/or the Ethernet network segment 212 are provisioned as part of a Weave network, a fabric network, or a CHIP fabric network, the devices can communicate messages over those same UDP and/or TCP transports.

Tunneled Routing

A network tunnel (e.g., the secure tunnel 114) provides for the movement of data from one network to another across a foreign, and often untrusted, network. A network tunnel coupled with Internet Protocol-level routing can be used to form a virtual private network (VPN) with which a private network is extended across another, usually public, network such as the Internet or the access network 108. An access router that includes a functional combination of the network tunnel, IP routing, and the VPN can be delivered as a virtual service. An access router can run in a variety of contexts, including on dedicated or multi-function devices. The access router virtually connects two network segments (subnets) across an access network, extending the application network (e.g., a fabric network, a Weave network, a CHIP fabric network). Tunneled connections between access routers are encrypted to provide security and are mutually authenticated, for example, by certificates and/or key exchanges to authenticate that the network segments are segments within the same provisioned application network.

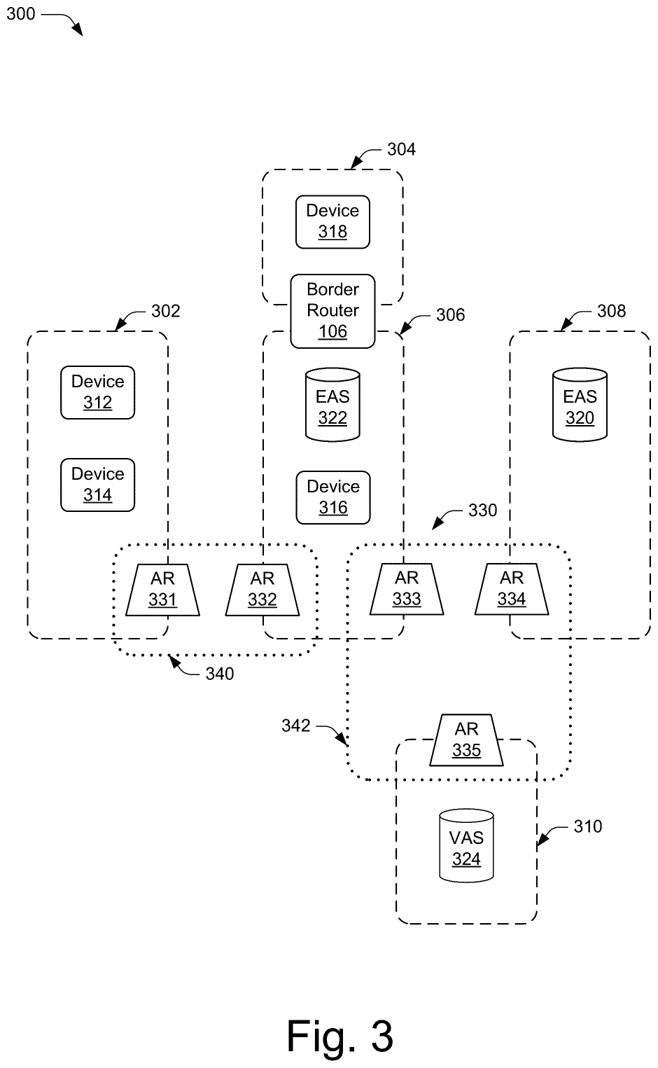

FIG. 3 illustrates an example fabric network 300 with which aspects of administering network-connected devices using tunneled routing can be implemented. The fabric network 300 is a logical network that includes fabric network segments 302, 204, 306, 308, and 310. Fabric network segment 302 includes devices 312 and 314, that may be, for example, wireless network devices 102, routers 206, end devices 208, Wi-Fi devices 210 and/or Ethernet devices 214. Fabric network segment 304 includes device 318 and the border router 106. The border router 106 connects the fabric network segment 304 to a Thread fabric network segment 306 that includes the border router 106, the device 316, and an on-premises EAS 322. The fabric network segment 308 includes on off-premises EAS 320 and the fabric network segment 310 includes a VAS 324.

Access routers 330 include the access routers 331, 332, 333, 334, and 335 (illustrated as “AR” for clarity of illustration). Each access router 330 runs as a service on any suitable device in its respective fabric network segment. For example, the access router 331 runs as a service on the device 314, the access routers 332 and 333 run as a service on the EAS 322, and so forth. The access routers 331 and 332 logically and virtually connect the fabric network segments 302 and 306 across an access network 340. The access routers 333, 334, and 335 logically and virtually connect the fabric network segments 306, 308, and 310 across an access network 342. Alternatively, the access networks 340 and 342 may be the same, single access network. The connection of fabric network segments with the access routers 300 enables the VAS of a third-party vendor to connect to that vendor's devices using the same tunneled network used for other fabric network applications. Additionally, devices operating in the fabric with limited resources (e.g., memory, computational resources, and/or power) can use a single networking stack for communication in the primary vendor's ecosystem and for vendor-specific communications.

The fabric network 300 uses an Internet Protocol version 6 (IPv6) unique-local address (ULA) addressing model. Subnet identifiers for each fabric network segment are assigned within the ULA addressing model. Well-known anycast addresses are assigned for services in the fabric network.

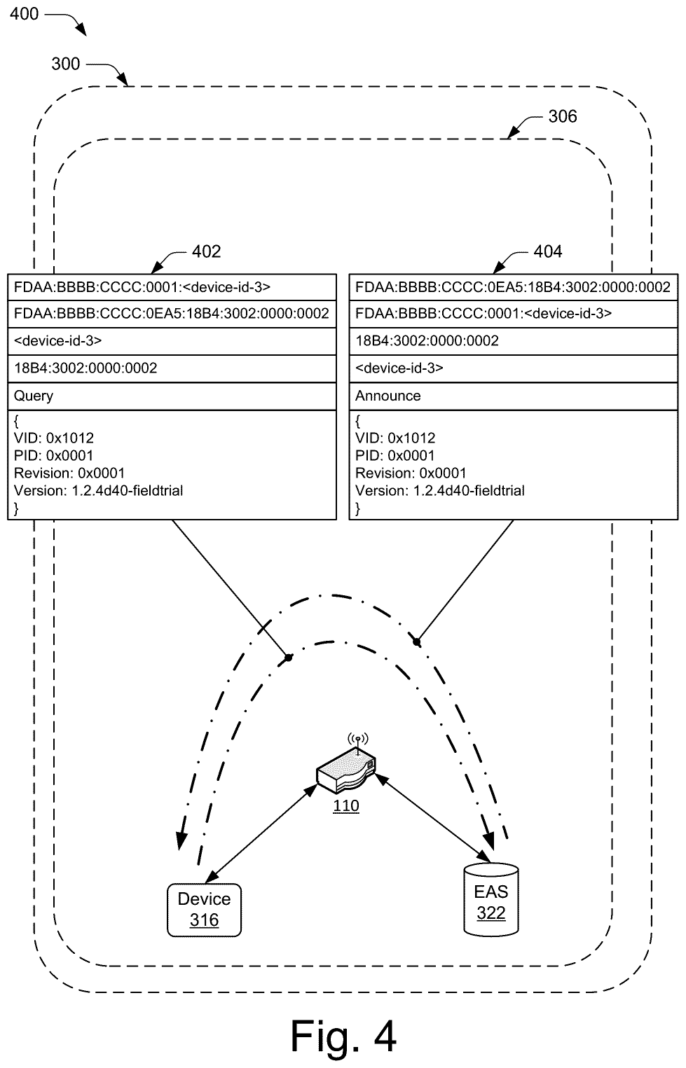

In the following examples of FIGS. 4-13, messages are illustrated by two protocol command messages, an announce command message from an EAS sent to a device in the fabric network 300 (e.g., an image announce sent to a device indicating that the EAS has a software update for the device) and a query command message from a device to an EAS (e.g., an image query sent by a device to an EAS to ask if a newer version of software is available for the device). Although the messages are illustrated as announce and query messages, other protocol commands use the same message and address formats, for example, messages that include announce and query commands related to file downloads, time of day and time synchronization, file uploads, vending of operational certificates for authentication, device and resource directories or registries, data management proxies (e.g., for commands, state, and/or settings), or the like.

The example announce and query messages illustrated in FIGS. 4-13 each include an IPv6 source address, an IPv6 destination address, a source IID, a destination IID, a protocol command identifier (“Announce” or “Query”), and a parameters field that includes parameters associated with the protocol command, for example a vendor identifier (VID), a product identifier (PID), a revision, and a current software version. In the following examples of FIGS. 4-13, the following values are used; however, any suitable values can be used. The ULA routing prefix for the fabric network is: FDAA:BBBB:CCCC/56. An ecosystem administrative service (EAS) subnet is statically assigned the value: 0x0EA5. A vendor-specific administrative service (VAS) subnet is statically assigned the value: 0x0024. There may be more than one VAS for a fabric network, in which case each VAS is administratively assigned a unique subnet prefix. A primary Wi-Fi subnet is administratively assigned the value: 0x0001. A primary Thread subnet is administratively assigned the value: 0x0002. A well-known anycast interface identifier (IID) for an EAS service (e.g., a software update service) is assigned the value: 18B4:3002:0000:0002. A Wi-Fi Device is assigned an IID: <device-id-3>, a vendor identifier (VID): 0x1012, a product identifier (PID): 0x0001, a revision: 0x0001, and a current software version: 1.2.4d40-fieldtrial. A Thread Device is assigned an IID: <device-id-4>, a vendor identifier (VID): 0x2035, a product identifier (PID): 0x0002, a revision: 0x0001, and a current software version: 2.7.1b2.

In the following examples of FIGS. 4-13, the resulting IPv6 address of the EAS is FDAA:BBBB:CCCC:0EA5:18B4:3002:0000:0002. The resulting IPv6 address for the VAS is FDAA:BBBB:CCCC:0024:18B4:3002:0000:0002. The resulting IPv6 address for the Wi-Fi device 316 is FDAA:BBBB:CCCC:0001:<device-id3>. The resulting IPv6 address for the Thread device 318 is FDAA:BBBB:CCCC:0002:<device-id4>.

Ecosystem Administrative Service Configurations

FIG. 4 illustrates example message routing 400 between a device (Wi-Fi device or Ethernet device) and an in-premises EAS in accordance with aspects of administering network-connected devices using tunneled routing. The in-premises EAS 322 and the Wi-Fi device 316 are connected to an in-premises Wi-Fi subnet provided by the access point 110 in the fabric network segment 306. The access point 110 provides connectivity to the access network 108 which is not illustrated in FIG. 4 for the sake of illustration clarity. The EAS 322 and the Wi-Fi device 316 are in the same broadcast domain and network segment, so no tunneled routing is needed for EAS-related communication. However, the EAS 322, at the time it takes on the EAS anycast addresses on the EAS subnet, sends a Routing Advertisement (RA) message advertising the EAS subnet, on-link prefix: FDAA:BBBB:CCCC:0EA5/64.

To send a query message 402 (e.g., an unsolicited image query for a software update), the Wi-Fi device 316 forms the well-known anycast destination address including the ULA routing prefix (FDAA:BBBB:CCCC), the well-known EAS Subnet (0x0EA5), and well-known Software Update IID (18B4:3002:0000:0002). IPv6 neighbor discovery (ND) will resolve the Wi-Fi Medium Access Control (MAC) destination address to use for the message. When the Wi-Fi device 316 sends the query message 402, the default route will send the message using the Wi-Fi interface where it will reach the EAS 322 via the Wi-Fi access point 110.

To send an announce message 404 (e.g., an unsolicited image announce for a software update) to the device 316, the EAS 322 forms the device address including the ULA routing prefix (FDAA:BBBB:CCCC), the primary Wi-Fi subnet (0x0001), and the device IID for the device 316 (<device-id-3>). The EAS 322 may lookup the primary Wi-Fi subnet and device IID in its registry or directory. IPv6 neighbor discovery (ND) will resolve the Wi-Fi MAC destination address to use for the message. When the EAS 322 sends the announce message 404, the default route will send the message using the Wi-Fi interface where it will reach the device 316 via the Wi-Fi access point 110.

Alternatively, the fabric network segment 306 can be an Ethernet network segment instead of a Wi-Fi network segment. In this case, the Wi-Fi access point 110 can be replaced by an Ethernet switch, an Ethernet router, or an access point 110 that includes an Ethernet switch or router.

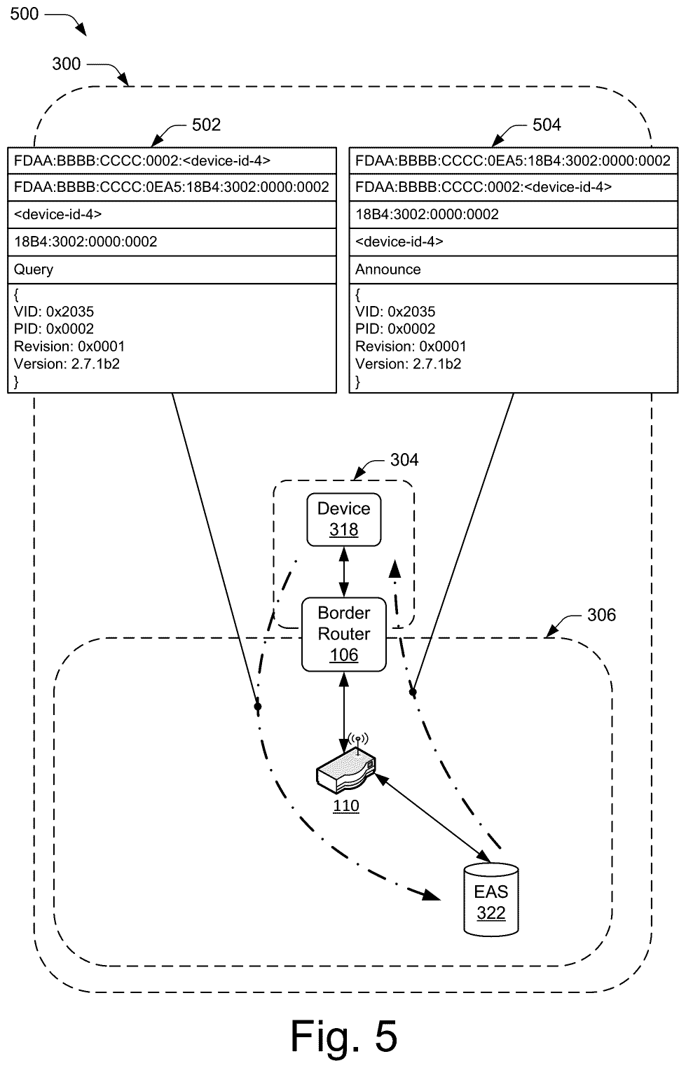

FIG. 5 illustrates example message routing 500 between a device (Thread device) and an in-premises EAS in accordance with aspects of administering network-connected devices using tunneled routing. The in-premises EAS 322 and the border router 106 are connected to an in-premises Wi-Fi subnet provided by the access point 110 in the fabric network segment 306. The Thread device 318 and the border router 106 are connected on the in-premises Thread subnet in the fabric network subnet 304. The access point 110 provides connectivity to the access network 108 which is not illustrated in FIG. 5 for the sake of illustration clarity. Because they reside on separate subnets, the EAS 322 and the Thread device 318 are not on the same broadcast domain. The border router 106 performs IPv6 destination routing between the Thread and Wi-Fi subnets.

To send a query message 502, the Thread device 318 forms the well-known anycast destination address including the ULA routing prefix (FDAA:BBBB:CCCC), the well-known EAS Subnet (0x0EA5), and well-known Software Update IID (18B4:3002:0000:0002). When the Thread device 318 sends the query message 502, the Thread mesh network provides the Thread MAC address resolution for the mesh destination of the message, whether the device 318 is deep in or at the edge of the mesh network. When the query message 502 reaches the border router 106, IPv6 ND in the border router 106 resolves the Wi-Fi MAC (or alternatively the Ethernet MAC) destination address of the EAS 322 for the query message 502 and the border router 106 determines a route to the EAS 322 using its routing table. The border router 106 sends the query message 502 using its Wi-Fi (or, alternatively, its Ethernet) interface to the access point 110 that forwards the query message 504 to the EAS 322.

To send an announce message 504 to the device 318, the EAS 322 forms the device address including the ULA routing prefix (FDAA:BBBB:CCCC), the primary Thread subnet (0x0002), and the device IID for the device 318 (<device-id-4>). The EAS 322 may lookup the primary Thread subnet and device IID in its registry or directory. The EAS 322 uses the FDAA:BBBB:CCCC:0002/64 network route, advertised by the border router 106, to send the announce message 504 to the border router 106 that forwards the announce message 504 across the Thread network to the device 318.

The examples described above, with respect to FIGS. 4 and 5, illustrate consistent addressing and communication techniques for access to an in-premises EAS for Wi-Fi, Ethernet, and Thread devices. However, all or a portion of the services proved by an EAS may also be hosted off-premises, for example in a cloud-based service. Accessing an EAS across an external network 108, such as the Internet, can impose constraints such lack of IPv6 support or Network Address Translation (NAT) at the interface to the external network. The following examples illustrate the application of tunneled routing to provide consistent addressing and communication techniques for access to out-of-premises EASs that overcome the constraints of NAT.

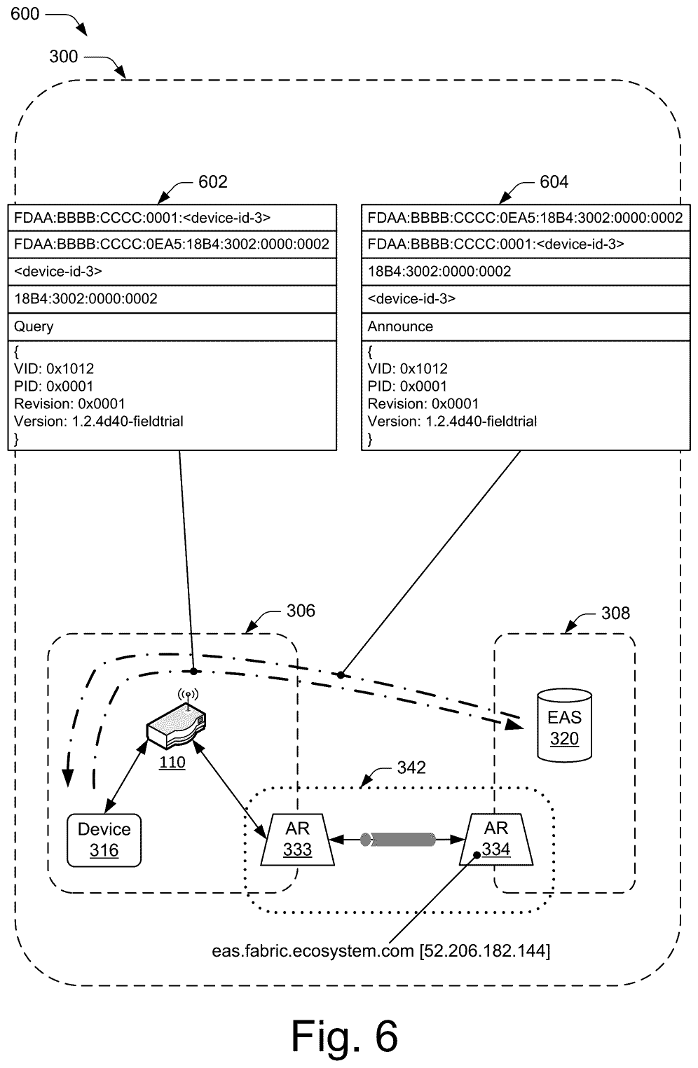

FIG. 6 illustrates example message routing 600 between a device (Wi-Fi device or Ethernet device) and an out-of-premises EAS in accordance with aspects of administering network-connected devices using tunneled routing. The out-of-premises EAS 320 and the Wi-Fi device 316 reside on different fabric network subnets 308 and 306, respectively. The device 316 is connected to an in-premises Wi-Fi subnet provided by the access point 110 in the fabric network segment 306. The access router (AR) 333 and the AR 334 provide secured, mutually-authenticated tunneled routing between the fabric network segments 306 and 308. For the sake of illustration, the ARs 333 and 334 are shown explicitly; however, the access router can be provided as a virtual service or function hosted by a device in its network segment. For example, the device 316 or the access point 110 can host the access router 333 as a virtual function. The EAS 320 can host the access router 334.

The access router 334 for the fabric network segment 308 is advertised on the public Internet with a Domain Name System (DNS) name that resolves to an IPv4 or IPv6 address. For example, the access router 334 is advertised with the DNS name, eas.fabric.ecosystem.com, which resolves to the IPv4 address 52.206.182.144. The out-of-premises EAS access router can create either 6-over-4 or 6-over-6 tunnels based on whether the DNS name of the access router resolves to an IPv4 or IPv6 address, respectively.

The out-of-premises EAS access router 334 is provisioned with a record to create an access route to the EAS 320 at eas.fabric.ecosystem.com. The access router 334 maintains an active, tunneled route to the EAS 320. Once the access route is established, the access router 333 advertises a FDAA:BBBB:CCCC:0EA5/64 network route to the out-of-premises EAS subnet 308 over the tunnel between the access router 333 and the access router 334.

To send a query message 602, the Wi-Fi device 316 forms the well-known anycast destination address including the ULA routing prefix (FDAA:BBBB:CCCC), the well-known EAS Subnet (0x0EA5), and well-known Software Update IID (18B4:3002:0000:0002). The Wi-Fi device 316 forms a destination address that is identical to the destination address formed as described with respect to FIG. 4 when tunnel routing was not used to reach the EAS. IPv6 neighbor discovery (ND) will resolve the Wi-Fi Medium Access Control (MAC) destination address of the access router 333 (the access router proximal to the device 316 in the fabric network segment 306) to use for the message based on the FDAA:BBBB:CCCC:0EA5/64 network route advertised by the access router 333. When the Wi-Fi device 316 sends the query message 602, the advertised route will send the message using the Wi-Fi interface where it will reach the EAS 320 via the secure tunnel between the access routers 333 and 334.

To send an announce message 604 to the device 316, the out-of-premises EAS 320 forms the device address including the ULA routing prefix (FDAA:BBBB:CCCC), the primary Wi-Fi subnet (0x0001), and the device IID for the device 316 (<device-id-3>) in the same manner described with respect to FIG. 4 above. The EAS 320 may lookup the primary Wi-Fi subnet and device IID in its registry or directory. When the EAS 320 sends the announce message 604, the message is routed through the secure tunnel between the access routers 333 and 334 to the device 316.

Unlike typical passive NAT64 solutions, this tunneled routing technique enables an out-of-premises EAS to asynchronously send an unsolicited announce or other message to the device 316 at any time since the tunneled route provides both an egress path out of the premises (fabric network segment 306 in this example) as well as a secured and mutually-authenticated ingress path into the premises. Any NAT or stateful firewalling that may be occurring at the in-premises Internet Service Provider (ISP) gateway or router is kept alive and open by the tunneled route relieving the burden of maintaining the NAT or stateful firewall for all devices communicating with the EAS.

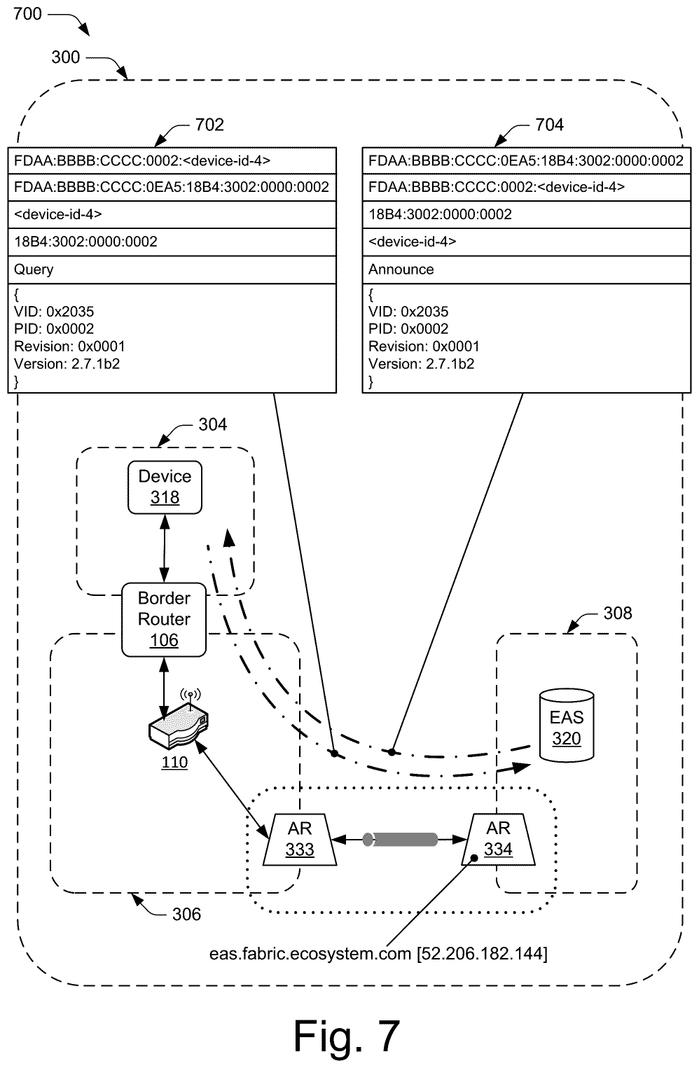

FIG. 7 illustrates example message routing 700 between a device (Thread device) and an out-of-premises EAS in accordance with aspects of administering network-connected devices using tunneled routing. The out-of-premises EAS 320 and the Thread device 318 reside on different fabric network subnets 308 and 304, respectively. The Thread device 318 and the border router 106 are connected on the in-premises Thread subnet (the fabric network subnet 304). The border router 106 and the access router 333 are connected to an in-premises Wi-Fi subnet provided by the access point 110 in the fabric network segment 306. The access point 110 provides connectivity to the access network 108 which is not illustrated in FIG. 7 for the sake of illustration clarity. The border router 106 performs IPv6 destination routing between the Thread and Wi-Fi subnets.

The access router 334 for the fabric network segment 308 is advertised on the public Internet with a Domain Name System (DNS) name that resolves to an IPv4 or IPv6 address. For example, the access router 334 is advertised with the DNS name, eas.fabric.ecosystem.com, which resolves to the IPv4 address 52.206.182.144. The out-of-premises EAS access router can create either 6-over-4 or 6-over-6 tunnels based on whether the DNS name of the access router resolves to an IPv4 or IPv6 address, respectively.

To send a query message 702, the Thread device 318 forms the well-known anycast destination address including the ULA routing prefix (FDAA:BBBB:CCCC), the well-known EAS Subnet (0x0EA5), and well-known Software Update IID (18B4:3002:0000:0002). The Thread device 318 forms a destination address that is identical to the destination address formed as described with respect to FIG. 5 when tunnel routing was not used to reach the EAS. When the Thread device 318 sends the query message 702, the Thread mesh network provides the Thread MAC address resolution for the mesh destination of the message, whether the device 318 is deep in or at the edge of the mesh network. When the query message 702 reaches the border router 106, IPv6 ND in the border router 106 resolves the Wi-Fi MAC (or alternatively the Ethernet MAC) destination address of the access router 333 (the access router proximal to the device 318 in the fabric network segment 304) to use for the message based on the FDAA:BBBB:CCCC:0EA5/64 network route advertised by the access router 333. When the Thread device 318 sends the query message 702, the advertised route will send the message to the EAS 320 via the secure tunnel between the access routers 333 and 334.

To send an announce message 704 to the device 318, the out-of-premises EAS 320 forms the device address including the ULA routing prefix (FDAA:BBBB:CCCC), the primary Thread subnet (0x0002), and the device IID for the device 318 (<device-id-4>) in the same manner described with respect to FIG. 5 above. The EAS 320 may lookup the primary Thread subnet and device IID in its registry or directory. When the EAS 320 sends the announce message 704, the message is routed through the secure tunnel between the access routers 333 and 334 to the device 318 via the border router 106 in the fabric network segment 306.

Vendor Administrative Service Configurations

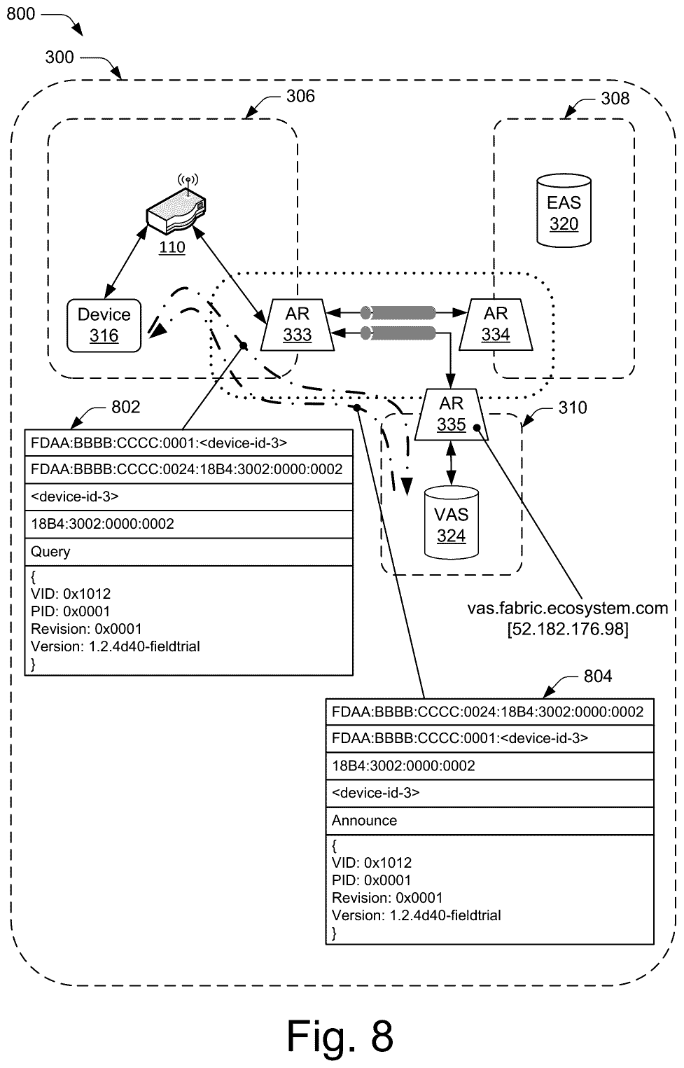

FIG. 8 illustrates example message routing 800 between a device (Wi-Fi device or Ethernet device) and a VAS in accordance aspects of administering network-connected devices using tunneled routing. The VAS 324 and the Wi-Fi device 316 reside on different fabric network subnets 310 and 306, respectively. The device 316 is connected to an in-premises Wi-Fi subnet provided by the access point 110 in the fabric network segment 306. The access router (AR) 333 and the AR 335 provide secured, mutually-authenticated tunneled routing between the fabric network segments 306 and 310. For the sake of illustration, the ARs 333 and 335 are shown explicitly; however, the access router can be provided as a virtual service or function hosted by a device on its network segment. For example, the device 316 or the access point 110 can host the access router 333 as a virtual function. The VAS 324 can host the access router 335.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The VAS access router can create either 6-over-4 or 6-over-6 tunnels based on whether the DNS name of the access router resolves to an IPv4 or IPv6 address, respectively.

The VAS access router 335 is provisioned with a record to create an access route to the VAS 324 at vas.fabric.ecosystem.com. The access router 335 maintains an active, tunneled route to the VAS 324. Once the access route is established, the access router 333 advertises a FDAA:BBBB:CCCC:0024/64 network route to the out-of-premises VAS subnet 310 over the tunnel between the access router 333 and the access router 335.

To send a query message 802, the Wi-Fi device 316 forms the well-known anycast destination address including the ULA routing prefix (FDAA:BBBB:CCCC), the VAS Subnet (0x0024), and well-known Software Update IID (18B4:3002:0000:0002). IPv6 neighbor discovery (ND) will resolve the Wi-Fi Medium Access Control (MAC) destination address of the access router 333 (the access router proximal to the device 316 in the fabric network segment 306) to use for the message based on the FDAA:BBBB:CCCC:0024/64 network route advertised by the access router 333. When the Wi-Fi device 316 sends the query message 802, the advertised route will send the message using the Wi-Fi interface where it will reach the VAS 324 via the secure tunnel between the access routers 333 and 335.

To send an announce message 804 to the device 316, the VAS 324 forms the device address including the ULA routing prefix (FDAA:BBBB:CCCC), the primary Wi-Fi subnet (0x0001), and the device IID for the device 316 (<device-id-3>) in the same manner described with respect to FIGS. 4 and 6 above. The VAS 324 may lookup the primary Wi-Fi subnet and device IID in its registry or directory. When the VAS 324 sends the announce message 804, the message is routed through the secure tunnel between the access routers 333 and 335 to the device 316.

Unlike typical passive NAT64 solutions, this tunneled routing technique enables an out-of-premises VAS to asynchronously send an unsolicited announce message or other message to the device 316 at any time since the tunneled route provides both an egress path out of the premises (fabric network segment 306 in this example) as well as a secured and mutually-authenticated ingress path into the premises. Any NAT or stateful firewalling that may be occurring at the in-premises ISP gateway or router is kept alive and open by the tunneled route relieving the burden of maintaining the NAT or stateful firewall for all devices communicating with the VAS.

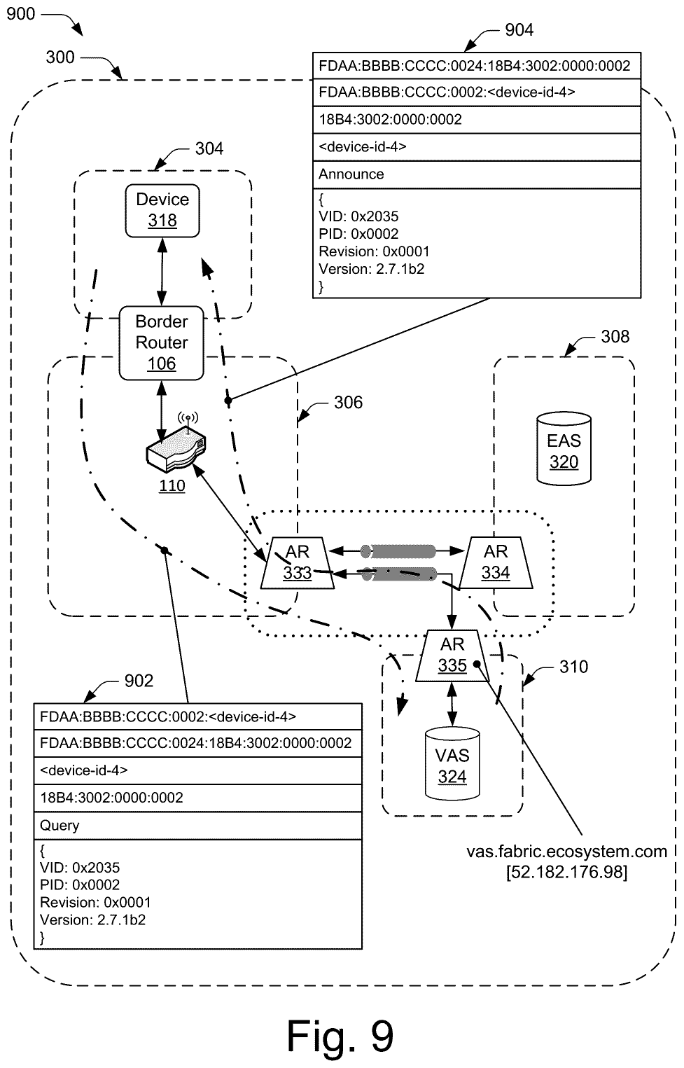

FIG. 9 illustrates example message routing 900 between a device (Thread device) and a VAS in accordance aspects of administering network-connected devices using tunneled routing. The Thread device 318 and VAS 324 reside on different fabric network subnets 304 and 310. The Thread device 318 and the border router 106 are connected on the in-premises Thread subnet in the fabric network subnet 304. The border router 106 and the access router 333 are connected to an in-premises Wi-Fi subnet provided by the access point 110 in the fabric network segment 306. The access point 110 provides connectivity to the access network 108 which is not illustrated in FIG. 9 for the sake of illustration clarity. The border router 106 performs IPv6 destination routing between the Thread and Wi-Fi subnets.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The VAS access router can create either 6-over-4 or 6-over-6 tunnels based on whether the DNS name of the access router resolves to an IPv4 or IPv6 address, respectively.

The VAS access router 335 is provisioned with a record to create an access route to the VAS 324 at vas.fabric.ecosystem.com. The access router 335 maintains an active, tunneled route to the VAS 324. Once the access route is established, the access router 333 advertises a FDAA:BBBB:CCCC:0024/64 network route to the out-of-premises VAS subnet 310 over the tunnel between the access router 333 and the access router 335.

To send a query message 902, the Thread device 318 forms the well-known anycast destination address including the ULA routing prefix (FDAA:BBBB:CCCC), the VAS Subnet (0x0024), and well-known Software Update IID (18B4:3002:0000:0002). When the Thread device 318 sends the query message 902, the Thread mesh network provides the Thread MAC address resolution for the mesh destination of the message, whether the device 318 is deep in or at the edge of the mesh network. When the query message 902 reaches the border router 106, IPv6 ND in the border router 106 resolves the Wi-Fi MAC (or alternatively the Ethernet MAC) destination address of the access router 333 (the access router proximal to the device 318 in the fabric network segment 304) to use for the message based on the FDAA:BBBB:CCCC:0024/64 network route advertised by the access router 333. When the Thread device 318 sends the query message 902, the advertised route will send the message to the VAS 324 via the secure tunnel between the access routers 333 and 335.

To send an announce message 904 to the device 318, the VAS 324 forms the device address including the ULA routing prefix (FDAA:BBBB:CCCC), the primary Thread subnet (0x0002), and the device IID for the device 318 (<device-id-4>) in the same manner described with respect to FIGS. 5 and 7 above. The VAS 324 may lookup the primary Thread subnet and device IID in its registry or directory. When the VAS 324 sends the announce message 904, the message is routed through the secure tunnel between the access routers 333 and 335 to the device 318 via the border router 106 in the fabric network segment 306.

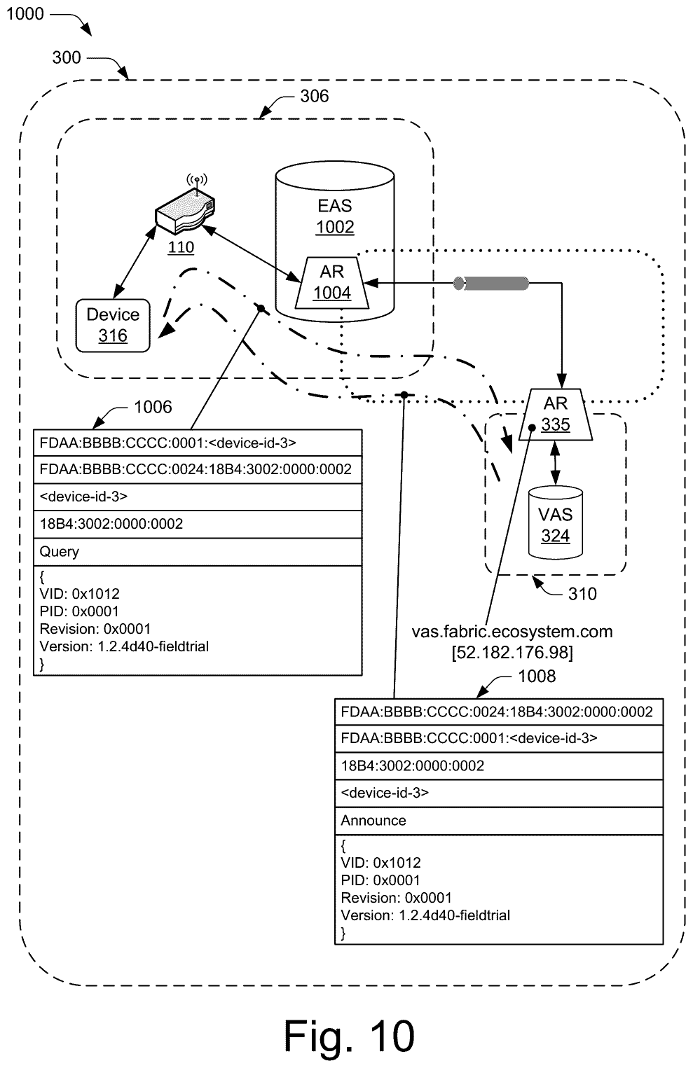

FIG. 10 illustrates example message routing 1000 between a device (Wi-Fi device or Ethernet device) and a VAS in accordance aspects of administering network-connected devices using tunneled routing. The Wi-Fi device 316 and the VAS 324 reside on different fabric network subnets 306 and 310. The device 316 is connected to an in-premises Wi-Fi subnet provided by the access point 110 in the fabric network segment 306. The EAS 1002 includes an access router 1004. The access router 1004 and the AR 335 provide secured, mutually-authenticated tunneled routing between the fabric network segments 306 and 310.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The VAS access router can create either 6-over-4 or 6-over-6 tunnels based on whether the DNS name of the access router resolves to an IPv4 or IPv6 address, respectively.

The VAS access router 335 is provisioned with a record to create an access route to the VAS 324 at vas.fabric.ecosystem.com. The access router 335 maintains an active, tunneled route to the VAS 324. Once the access route is established, the access router 1004 advertises a FDAA:BBBB:CCCC:0024/64 network route to the out-of-premises VAS subnet 310 over the tunnel between the access router 1004 and the access router 335.

To send a query message 1006, the Wi-Fi device 316 forms the well-known anycast destination address including the ULA routing prefix (FDAA:BBBB:CCCC), the VAS Subnet (0x0024), and well-known Software Update IID (18B4:3002:0000:0002). IPv6 neighbor discovery (ND) will resolve the Wi-Fi Medium Access Control (MAC) destination address of the access router 1004 (the access router proximal to the device 316 in the fabric network segment 306) to use for the message based on the FDAA:BBBB:CCCC:0024/64 network route advertised by the access router 1004. When the Wi-Fi device 316 sends the query message 1006, the advertised route will send the message using the Wi-Fi interface where it will reach the VAS 324 via the secure tunnel between the access routers 1004 and 335.

To send an announce message 1008 to the device 316, the VAS 324 forms the device address including the ULA routing prefix (FDAA:BBBB:CCCC), the primary Wi-Fi subnet (0x0001), and the device IID for the device 316 (<device-id-3>) in the same manner described with respect to FIGS. 4, 6, and 8 above. The VAS 324 may lookup the primary Wi-Fi subnet and device IID in its registry or directory. When the VAS 324 sends the announce message 1008, the message is routed through the secure tunnel between the access routers 1004 and 335 to the device 316.

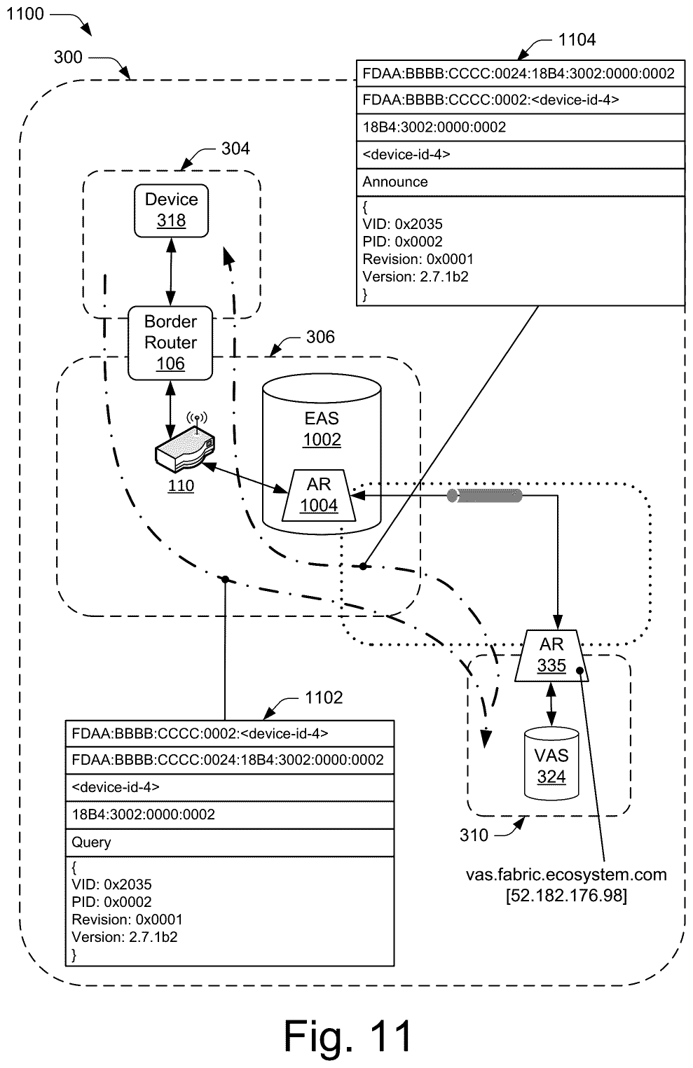

FIG. 11 illustrates example message routing 1100 between a device (Thread device) and a VAS in accordance aspects of administering network-connected devices using tunneled routing. The Thread device 318 and VAS 324 reside on different fabric network subnets 304 and 310. The Thread device 318 and the border router 106 are connected on the in-premises Thread subnet in the fabric network subnet 304. The EAS 1002 includes an access router 1004. The border router 106 and the EAS 1002 are connected to an in-premises Wi-Fi subnet provided by the access point 110 in the fabric network segment 306. The access point 110 provides connectivity to the access network 108 which is not illustrated in FIG. 11 for the sake of illustration clarity. The border router 106 performs IPv6 destination routing between the Thread and Wi-Fi subnets.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The VAS access router can create either 6-over-4 or 6-over-6 tunnels based on whether the DNS name of the access router resolves to an IPv4 or IPv6 address, respectively.

The VAS access router 335 is provisioned with a record to create an access route to the VAS 324 at vas.fabric.ecosystem.com. The access router 335 maintains an active, tunneled route to the VAS 324. Once the access route is established, the access router 1004 advertises a FDAA:BBBB:CCCC:0024/64 network route to the out-of-premises VAS subnet 310 over the tunnel between the access router 1004 and the access router 335.

To send a query message 1102, the Thread device 318 forms the well-known anycast destination address including the ULA routing prefix (FDAA:BBBB:CCCC), the VAS Subnet (0x0024), and well-known Software Update IID (18B4:3002:0000:0002). When the Thread device 318 sends the query message 1102, the Thread mesh network provides the Thread MAC address resolution for the mesh destination of the message, whether the device 318 is deep in or at the edge of the mesh network. When the query message 1102 reaches the border router 106, IPv6 ND in the border router 106 resolves the Wi-Fi MAC (or alternatively the Ethernet MAC) destination address of the access router 1004 (the access router proximal to the device 318 in the fabric network segment 304) to use for the message based on the FDAA:BBBB:CCCC:0024/64 network route advertised by the access router 1004. When the Thread device 318 sends the query message 1102, the advertised route will send the message to the VAS 324 via the secure tunnel between the access routers 1004 and 335.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The DNS for the VAS access router can create either 6-over-4 or 6-over-6 tunnels based on whether the DNS name of the access router resolves to an IPv4 or IPv6 address, respectively.

To send an announce message 1104 to the device 318, the VAS 324 forms the device address including the ULA routing prefix (FDAA:BBBB:CCCC), the primary Thread subnet (0x0002), and the device IID for the device 318 (<device-id-4>) in the same manner described with respect to FIGS. 5, 7, and 9 above. The VAS 324 may lookup the primary Thread subnet and device IID in its registry or directory. When the VAS 324 sends the announce message 1104, the message is routed through the secure tunnel between the access routers 1004 and 335 to the device 318 via the border router 106 in the fabric network segment 306.

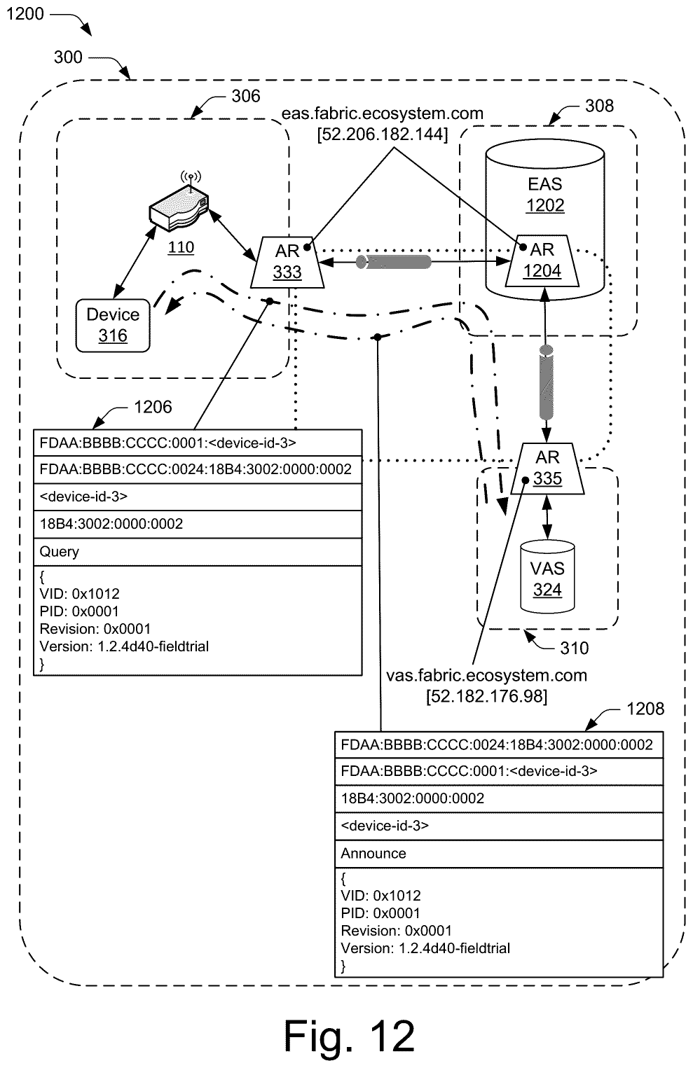

FIG. 12 illustrates example message routing 1200 between a device (Wi-Fi device or Ethernet device) and a VAS in accordance aspects of administering network-connected devices using tunneled routing. The Wi-Fi device 316 and the VAS 324 reside on different fabric network subnets 306 and 310. An EAS 1202 resides on fabric network subnet 308. The device 316 is connected to an in-premises Wi-Fi subnet provided by the access point 110 in the fabric network segment 306. The EAS 1202 includes an access router 1204. The access router 1204 and the access router 335 provide secured, mutually-authenticated tunneled routing between the fabric network segments 308 and 310. The access router 1204 and the access router 333 provide secured, mutually-authenticated tunneled routing between the fabric network segments 306 and 308. In this example, the access router 1204 provides access for VAS communications to and from devices in the in-premises fabric network segments.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The VAS access router can create either 6-over-4 or 6-over-6 tunnels based on whether the DNS name of the access router resolves to an IPv4 or IPv6 address, respectively.

The VAS access router 335 is provisioned with a record to create an access route to the VAS 324 at vas.fabric.ecosystem.com. The access router 1204 maintains an active, tunneled route to the VAS 324. Once the access route is established, the access router 1204 advertises a FDAA:BBBB:CCCC:0024/64 network route to the out-of-premises VAS subnet 310 over the tunnel between the access router 1204 and the access router 335.

To send a query message 1206, the Wi-Fi device 316 forms the well-known anycast destination address including the ULA routing prefix (FDAA:BBBB:CCCC), the VAS Subnet (0x0024), and well-known Software Update IID (18B4:3002:0000:0002). IPv6 neighbor discovery (ND) will resolve the Wi-Fi Medium Access Control (MAC) destination address of the access router 1004 (the access router proximal to the device 316 in the fabric network segment 306) to use for the message based on the FDAA:BBBB:CCCC:0024/64 network route advertised by the access router 1204. When the Wi-Fi device 316 sends the query message 1206, the advertised route will send the message using the Wi-Fi interface where it will reach the VAS 324 via the secure tunnels between the access routers 333 and 1204 and the access routers 1204 and 335.

To send an announce message 1208 to the device 316, the VAS 324 forms the device address including the ULA routing prefix (FDAA:BBBB:CCCC), the primary Wi-Fi subnet (0x0001), and the device IID for the device 316 (<device-id-3>) in the same manner described with respect to FIGS. 4, 6, 8, and 10 above. The VAS 324 may lookup the primary Wi-Fi subnet and device IID in its registry or directory. When the VAS 324 sends the announce message 1208, the message is routed through the secure tunnels between the access routers 335 and 1204 and the access routers 1204 and 333 to the device 316.

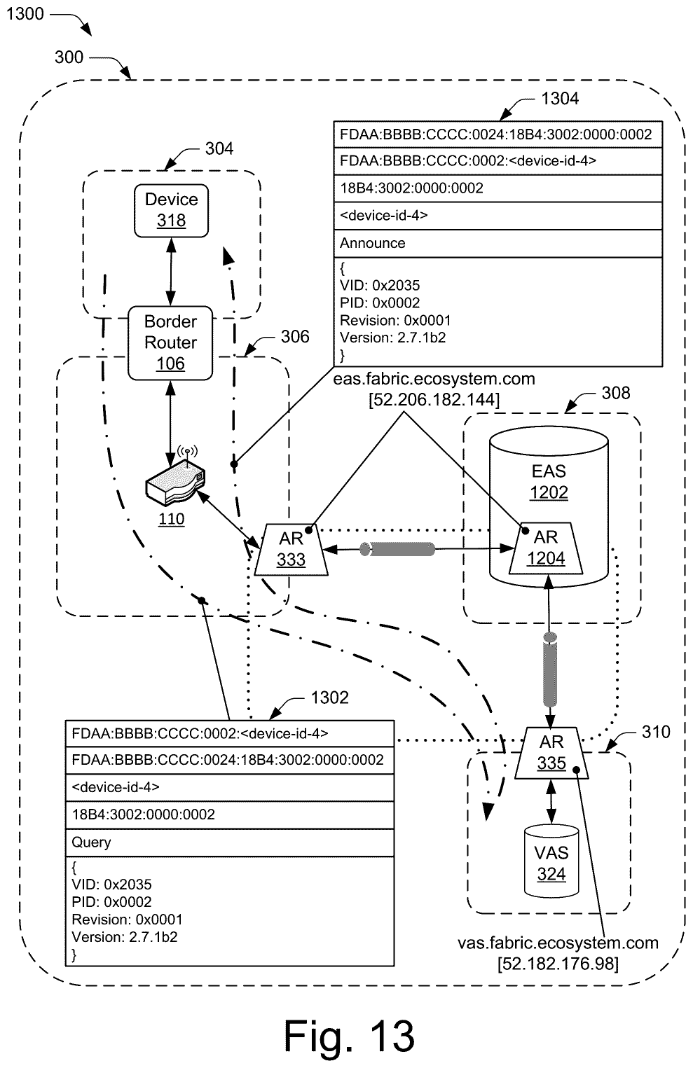

FIG. 13 illustrates example message routing 1300 between a device (Thread device) and a VAS in accordance aspects of administering network-connected devices using tunneled routing. The Thread device 318 and VAS 324 reside on different fabric network subnets 304 and 310. The EAS 1202 resides on fabric network subnet 308. The Thread device 318 and the border router 106 are connected on the in-premises Thread subnet in the fabric network subnet 304. The EAS 1202 includes an access router 1204. The border router 106 and the EAS 1202 are connected to an in-premises Wi-Fi subnet provided by the access point 110 in the fabric network segment 306. The access point 110 provides connectivity to the access network 108 which is not illustrated in FIG. 11 for the sake of illustration clarity. The border router 106 performs IPv6 destination routing between the Thread and Wi-Fi subnets.

The EAS 1202 includes an access router 1204. The access router 1204 and the access router 335 provide secured, mutually-authenticated tunneled routing between the fabric network segments 308 and 310. The access router 1204 and the access router 333 provide secured, mutually-authenticated tunneled routing between the fabric network segments 306 and 308. In this example, the access router 1204 provides access for VAS communications to and from devices in the in-premises fabric network segments.

The access router for the fabric network segment 310 is advertised on the public Internet with a Domain Name System (DNS) name that resolves to an IPv4 or IPv6 address. For example, the access router 335 is advertised with the DNS name, vas.fabric.ecosystem.com, which resolves to the IPv4 address 52.182.176.98. The DNS for the VAS access router can create either 6-over-4 or 6-over-6 tunnels based on whether the DNS name of the access router resolves to an IPv4 or IPv6 address, respectively.

The VAS access router 335 is provisioned with a record to create an access route to the VAS 324 at vas.fabric.ecosystem.com. The access router 1204 maintains an active, tunneled route to the VAS 324. Once the access route is established, the access router 1204 advertises a FDAA:BBBB:CCCC:0024/64 network route to the out-of-premises VAS subnet 310 over the tunnel between the access router 1204 and the access router 335.

To send a query message 1302, the Thread device 318 forms the well-known anycast destination address including the ULA routing prefix (FDAA:BBBB:CCCC), the VAS Subnet (0x0024), and well-known Software Update IID (18B4:3002:0000:0002). When the Thread device 318 sends the query message 1302, the Thread mesh network provides the Thread MAC address resolution for the mesh destination of the message, whether the device 318 is deep in or at the edge of the mesh network. When the query message 1302 reaches the border router 106, IPv6 ND in the border router 106 resolves the Wi-Fi MAC (or alternatively the Ethernet MAC) destination address of the access router 1204 (the access router proximal to the device 318 in the fabric network segment 304) to use for the message based on the FDAA:BBBB:CCCC:0024/64 network route advertised by the access router 1204. When the Thread device 318 sends the query message 1302, the advertised route will send the message to the VAS 324 via the secure tunnels between the access routers 333 and 1204 and the access routers 1204 and 335.

To send an announce message 1304 to the device 318, the VAS 324 forms the device address including the ULA routing prefix (FDAA:BBBB:CCCC), the primary Thread subnet (0x0002), and the device IID for the device 318 (<device-id-4>) in the same manner described with respect to FIGS. 5, 7, 9, and 11 above. The VAS 324 may lookup the primary Thread subnet and device IID in its registry or directory. When the VAS 324 sends the announce message 1304, the message is routed through the secure tunnels between the access routers 335 and 1204 and the access routers 1204 and 333 to the device 318.

### Example Method

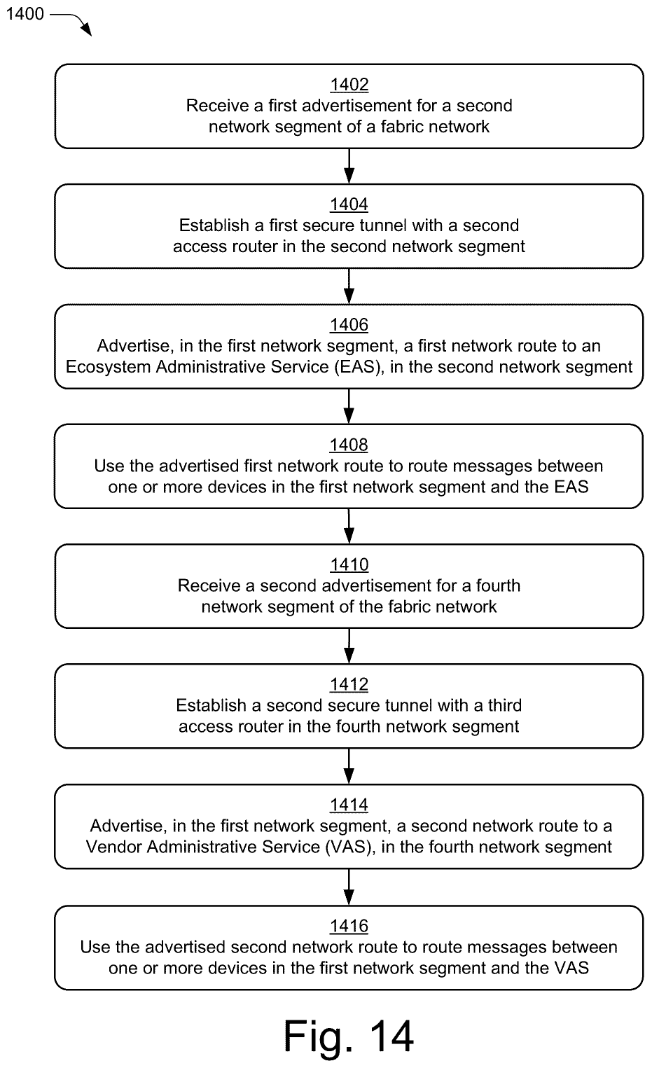

Example method 1400 is described with reference to FIG. 14 in accordance with one or more aspects of administering network-connected devices using tunneled routing. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 14 illustrates example method(s) 1400 of administering network-connected devices using tunneled routing as generally related to securely accessing administrative services using an access router in a network segment of a fabric network. At block 1402, a first access router in a first network segment of a fabric network receives a first advertisement for a second network segment of the fabric network. For example, a first access router (e.g., the access router 333) in a first network segment (e.g., the fabric network segment 306) of a fabric network (e.g., the fabric network 300) receives a first advertisement for a second network segment (e.g., the fabric network segment 308) that includes an Ecosystem Administrative Service (e.g., the EAS 320) of the fabric network.

At block 1404, the first access router establishes a first secure tunnel with a second access router in the second network segment. For example, the first access router establishes a network tunnel that is secure and mutually authenticated with a second access router (e.g., the access router 334) in the second network segment.

At block 1406, the first access router advertises, in the first network segment, a first network route to the Ecosystem Administrative Service (EAS), in the second network segment. For example, the first access router advertises, in the first network segment, a first network route to the EAS, in the second network segment that includes an IPv6 ULA routing prefix and a subnet identifier of the second network segment.

At block 1408, the first access router uses the advertised first network route to route messages between one or more devices in the first network segment and the EAS. For example, the first access router uses the advertised first network route to route messages (e.g., messages 602, 604, 702, 704, 802, and 804) between one or more devices (e.g., the device 316 or the border router 106) in the first network segment and the EAS in the second network segment. The border router may in turn relay messages between the first network segment and a third network segment (e.g., the fabric network segment 304).

At block 1410, the first access router in the first network segment of the fabric network receives a second advertisement for a fourth network segment of the fabric network. For example, the first access router in the first network segment of the fabric network receives a second advertisement for a fourth network segment (e.g., the fabric network segment 310) that includes a Vendor Administrative Service (e.g., the VAS 324) of the fabric network.

At block 1412, the first access router establishes a second secure tunnel with a third access router in the fourth network segment. For example, the first access router establishes a network tunnel that is secure and mutually authenticated with a third access router (e.g., the access router 335) in the fourth network segment.

At block 1414, the first access router advertises, in the first network segment, a second network route to the Vendor Administrative Service (VAS), in the fourth network segment. For example, first access router advertises, in the first network segment, a second network route to the VAS, in the fourth network segment that includes an IPv6 ULA routing prefix and a subnet identifier of the fourth network segment.

At block 1416, the first access router uses the advertised second network route to route messages between one or more devices in the first network segment and the VAS. For example, the first access router uses the advertised second network route to route messages (e.g., messages 902, 904, 1006, 1008, 1102, 1104, 1206, 1208, 1302, and 1304) between one or more devices (e.g., the device 316 or the border router 106) in the first network segment and the VAS in the fourth network segment. The border router may in turn relay messages between the first network segment and a fourth network segment (e.g., the fabric network segment 304).

### Example Environments and Devices

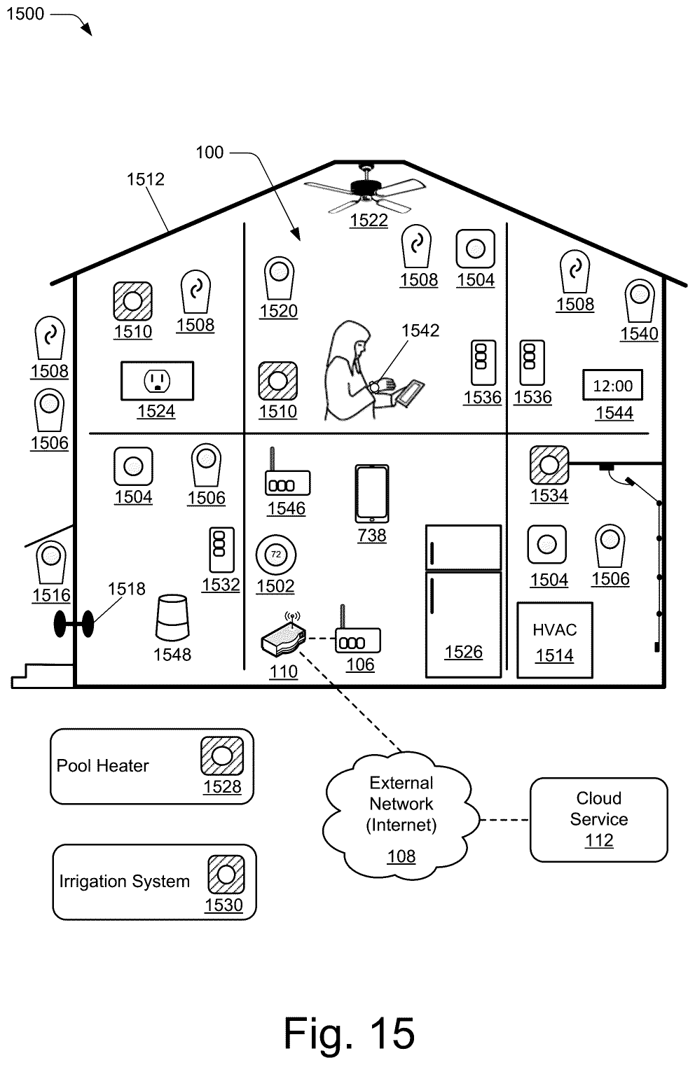

FIG. 15 illustrates an example environment 1500 in which a fabric, Weave, or CHIP network 100, 200, and/or 300 and aspects of administering network-connected devices using tunneled routing can be implemented. Generally, the environment 1500 includes the home area network (HAN) 200 implemented as part of a home or other type of structure with any number of wireless network devices that are configured for communication in a wireless network. For example, the wireless network devices can include a thermostat 1502, hazard detectors 1504 (e.g., for smoke and/or carbon monoxide), cameras 1506 (e.g., indoor and outdoor), lighting units 1508 (e.g., indoor and outdoor), and any other types of wireless network devices 1510 that are implemented inside and/or outside of a structure 1512 (e.g., in a home environment). In this example, the wireless network devices can also include any of the previously described devices, such as a border router 106, as well as any of the devices implemented as a router device 206, and/or as an end device 208.

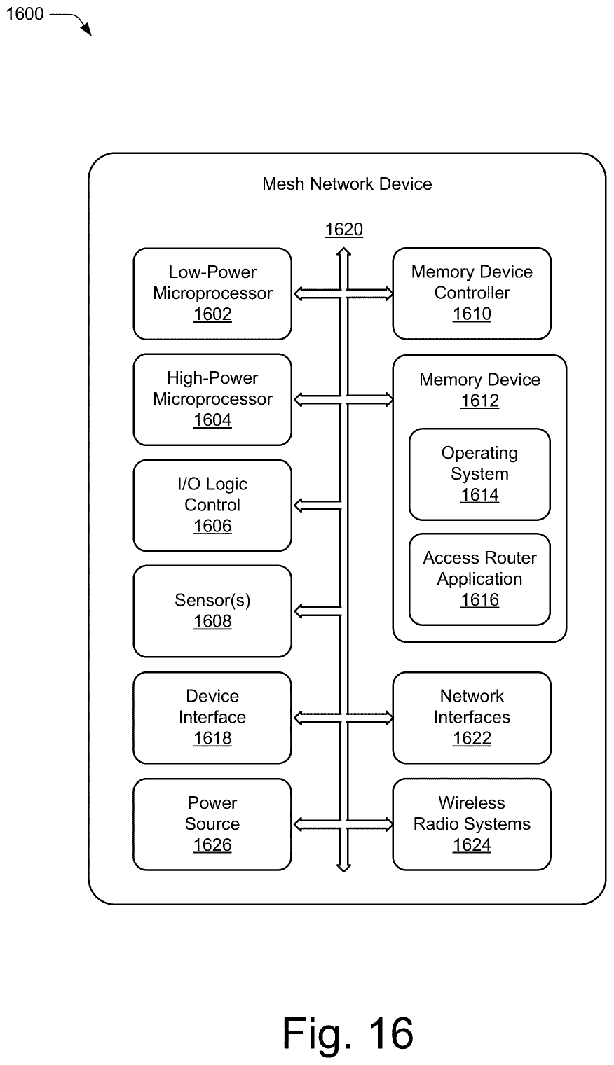

In the environment 1500, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 16.

In implementations, the thermostat 1502 may include a Nest® Learning Thermostat that detects ambient climate characteristics (e.g., temperature and/or humidity) and controls a HVAC system 1514 in the home environment. The learning thermostat 1502 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 1504 can be implemented to detect the presence of a hazardous substance or a substance indicative of a hazardous substance (e.g., smoke, fire, or carbon monoxide). In examples of wireless interconnection, a hazard detector 1504 may detect the presence of smoke, indicating a fire in the structure, in which case the hazard detector that first detects the smoke can broadcast a low-power wake-up signal to all of the connected wireless network devices. The other hazard detectors 1504 can then receive the broadcast wake-up signal and initiate a high-power state for hazard detection and to receive wireless communications of alert messages. Further, the lighting units 1508 can receive the broadcast wake-up signal and activate in the region of the detected hazard to illuminate and identify the problem area. In another example, the lighting units 1508 may activate in one illumination color to indicate a problem area or region in the structure, such as for a detected fire or break-in, and activate in a different illumination color to indicate safe regions and/or escape routes out of the structure.

In various configurations, the wireless network devices 1510 can include an entryway interface device 1516 that functions in coordination with a network-connected door lock system 1518, and that detects and responds to a person's approach to or departure from a location, such as an outer door of the structure 1512. The entryway interface device 1516 can interact with the other wireless network devices based on whether someone has approached or entered the smart-home environment. An entryway interface device 1516 can control doorbell functionality, announce the approach or departure of a person via audio or visual means, and control settings on a security system, such as to activate or deactivate the security system when occupants come and go. The wireless network devices 1510 can also include other sensors and detectors, such as to detect ambient lighting conditions, detect room-occupancy states (e.g., with an occupancy sensor 1520), and control a power and/or dim state of one or more lights. In some instances, the sensors and/or detectors may also control a power state or speed of a fan, such as a ceiling fan 1522. Further, the sensors and/or detectors may detect occupancy in a room or enclosure and control the supply of power to electrical outlets or devices 1524, such as if a room or the structure is unoccupied.

The wireless network devices 1510 may also include connected appliances and/or controlled systems 1526, such as refrigerators, stoves and ovens, washers, dryers, air conditioners, pool heaters 1528, irrigation systems 1530, security systems 1532, and so forth, as well as other electronic and computing devices, such as televisions, entertainment systems, computers, intercom systems, garage-door openers 1534, ceiling fans 1522, control panels 1536, and the like. When plugged in, an appliance, device, or system can announce itself to the home area network as described above and can be automatically integrated with the controls and devices of the home area network, such as in the home. It should be noted that the wireless network devices 1510 may include devices physically located outside of the structure, but within wireless communication range, such as a device controlling a swimming pool heater 1528 or an irrigation system 1530.

As described above, the HAN 200 includes a border router 106 that interfaces for communication with an external network, outside the HAN 200. The border router 106 connects to an access point 110, which connects to the access network 108, such as the Internet. A cloud service 112, which is connected via the access network 108, provides services related to and/or using the devices within the HAN 200. By way of example, the cloud service 112 can include applications for connecting end user devices 1538, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, and so forth. For example, a user can control the thermostat 1502 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 1540 detects that the room is dark and when the occupancy sensor 1520 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 1508 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 1508 that lead to a safe exit. The light units 1508 may also be turned-on to indicate the direction along an exit route that a person should travel to safely exit the structure.

The various wireless network devices may also be implemented to integrate and communicate with wearable computing devices 1542, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 1510 may also include a network-connected alarm clock 1544 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 1502 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 1502 so as to pre-heat or cool the environment to a desired setting and turning-on or turning-off the lights 1508.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 1500 may include one or more wireless network devices that function as a hub 1546. The hub 1546 may be a general-purpose home automation hub, or an application-specific hub, such as a security hub, an energy management hub, an HVAC hub, and so forth. The functionality of a hub 1546 may also be integrated into any wireless network device, such as a network-connected thermostat device or the border router 106. Hosting functionality on the hub 1546 in the structure 1512 can improve reliability when the user's internet connection is unreliable, can reduce latency of operations that would normally have to connect to the cloud service 112, and can satisfy system and regulatory constraints around local access between wireless network devices.

Additionally, the example environment 1500 includes a network-connected-speaker 1548. The network-connected speaker 1548 provides voice assistant services that include providing voice control of network-connected devices. The functions of the hub 1546 may be hosted in the network-connected speaker 1548. The network-connected speaker 1548 can be configured to communicate via the wireless mesh network 202, the Wi-Fi network 204, or both.

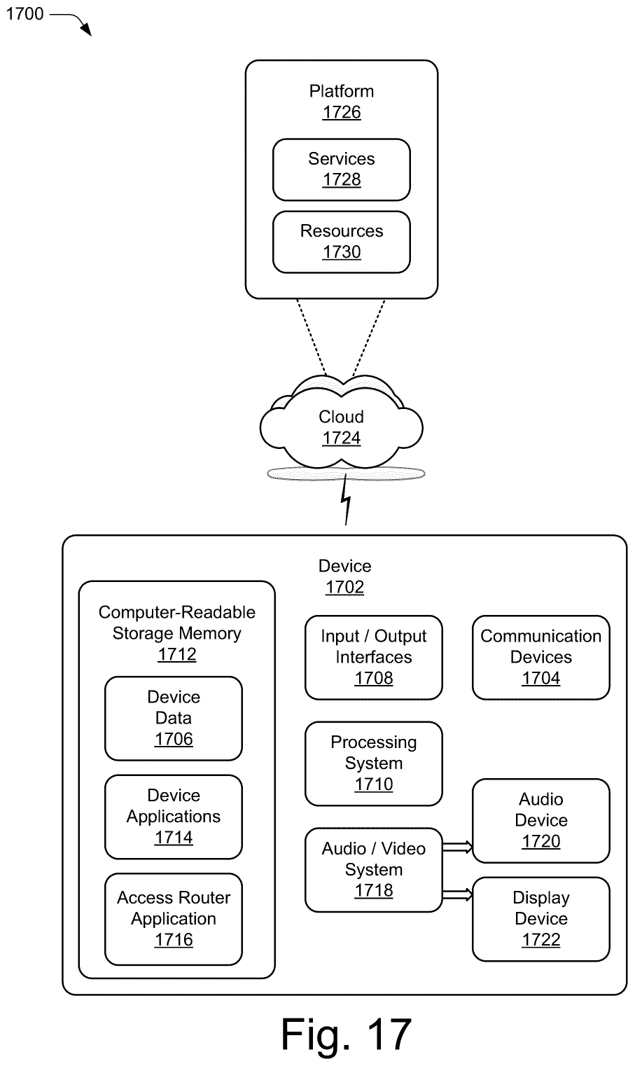

FIG. 16 illustrates an example wireless network device 1600 that can be implemented as any of the wireless network devices in a home area network (fabric network, Weave network, CHIP fabric network) in accordance with one or more aspects of administering network-connected devices using tunneled routing as described herein. The device 1600 can be integrated with electronic circuitry, microprocessors, memory, input output (I/O) logic control, communication interfaces and components, as well as other hardware, firmware, and/or software to implement the device in a home area network. Further, the wireless network device 1600 can be implemented with various components, such as with any number and combination of different components as further described with reference to the example device shown in FIG. 17.

In this example, the wireless network device 1600 includes a low-power microprocessor 1602 and a high-power microprocessor 1604 (e.g., microcontrollers or digital signal processors) that process executable instructions. The device also includes an input-output (I/O) logic control 1606 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 1602 and the high-power microprocessor 604 can also support one or more different device functionalities of the device. For example, the high-power microprocessor 1604 may execute computationally intensive operations, whereas the low-power microprocessor 1602 may manage less-complex processes such as detecting a hazard or temperature from one or more sensors 1608. The low-power processor 1602 may also wake or initialize the high-power processor 1604 for computationally intensive processes.

The one or more sensors 1608 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 1608 may include any one or a combination of temperature sensors, humidity sensors, hazard-related sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 1600 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 1600 includes a memory device controller 1610 and a memory device 1612, such as any type of a nonvolatile memory and/or other suitable electronic data storage device. The wireless network device 1600 can also include various firmware and/or software, such as an operating system 1614 that is maintained as computer executable instructions by the memory and executed by a microprocessor. The device software may also include an access router application 1616 that implements aspects of administering network-connected devices using tunneled routing. The wireless network device 1600 also includes a device interface 1618 to interface with another device or peripheral component and includes an integrated data bus 1620 that couples the various components of the wireless network device for data communication between the components. The data bus in the wireless network device may also be implemented as any one or a combination of different bus structures and/or bus architectures.

The device interface 1618 may receive input from a user and/or provide information to the user (e.g., as a user interface), and a received input can be used to determine a setting. The device interface 1618 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 1618 may also receive inputs from any number of peripherals, such as buttons, a keypad, a switch, a microphone, and an imager (e.g., a camera device).

The wireless network device 1600 can include network interfaces 1622, such as a home area network interface for communication with other wireless network devices in a home area network, and an external network interface for network communication, such as via the Internet. The wireless network device 1600 also includes wireless radio systems 1624 for wireless communication with other wireless network devices via the home area network interface and for multiple, different wireless communications systems. The wireless radio systems 1624 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The wireless network device 1600 also includes a power source 1626, such as a battery and/or to connect the device to line voltage. An AC power source may also be used to charge the battery of the device.

FIG. 17 illustrates an example system 1700 that includes an example device 1702, which can be implemented as any of the wireless network devices that implement aspects of administering network-connected devices using tunneled routing as described with reference to the previous FIGS. 1-16. The example device 1702 may be any type of computing device, client device, mobile phone, tablet, communication, entertainment, gaming, media playback, and/or other type of device. Further, the example device 1702 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 1702 includes communication devices 1704 that enable wired and/or wireless communication of device data 1706, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 1704 can also include transceivers for cellular phone communication and/or for network data communication.

The device 1702 also includes input/output (I/O) interfaces 1708, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 1702 includes a processing system 1710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1702 may further include any type of a system bus or other data and command transfer system that couples the various components within the device. A system bus can include any one or combination of different bus structures and architectures, as well as control and data lines.

The device 1702 also includes computer-readable storage memory 1712, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 1712 provides storage of the device data 1706 and various device applications 1714, such as an operating system that is maintained as a software application with the computer-readable storage memory and executed by the processing system 1710. The device applications may also include a device manager, such as any form of a control application, software application, signal processing and control module, code that is native to a particular device, a hardware abstraction layer for a particular device, and so on. In this example, the device applications also include an access router application 1716 that implements aspects of administering network-connected devices using tunneled routing, such as when the example device 1702 is implemented as any of the wireless network devices described herein.

The device 1702 also includes an audio and/or video system 1718 that generates audio data for an audio device 1720 and/or generates display data for a display device 1722. The audio device and/or the display device include any devices that process, display, and/or otherwise render audio, video, display, and/or image data, such as the image content of a digital photo. In implementations, the audio device and/or the display device are integrated components of the example device 1702. Alternatively, the audio device and/or the display device are external, peripheral components to the example device. In aspects, at least part of the techniques described for administering network-connected devices using tunneled routing may be implemented in a distributed system, such as over a “cloud” 1724 in a platform 1726. The cloud 1724 includes and/or is representative of the platform 1726 for services 1728 and/or resources 1730.

The platform 1726 abstracts underlying functionality of hardware, such as server devices (e.g., included in the services 1728) and/or software resources (e.g., included as the resources 1730), and connects the example device 1702 with other devices, servers, etc. The resources 1730 may also include applications and/or data that can be utilized while computer processing is executed on servers that are remote from the example device 1702. Additionally, the services 1728 and/or the resources 1730 may facilitate subscriber network services, such as over the Internet, a cellular network, or Wi-Fi network. The platform 1726 may also serve to abstract and scale resources to service a demand for the resources 1730 that are implemented via the platform, such as in an interconnected device aspect with functionality distributed throughout the system 900. For example, the functionality may be implemented in part at the example device 1702 as well as via the platform 1726 that abstracts the functionality of the cloud 1724.

In the following some examples are described:

Example 1: A method of accessing administrative services by a first access router in a first network segment of a fabric network, the method comprising:
receiving a first advertisement for a second network segment of the fabric network;
establishing a first secure network tunnel with a second access router in the second network segment;
advertising, in the first network segment, a first network route to an Ecosystem Administrative Service, EAS, in the second network segment; and
using the advertised first network route, routing messages between one or more devices in the first network segment and the EAS.
   Example 2: The method of example 1, further comprising:
receiving a first message for the EAS from a first device in the first network segment; and
forwarding the first message, via the first secure tunnel to the EAS in the second network segment.
   Example 3: The method of example 2, further comprising:
based on forwarding the first message, receiving a first response message for the first device from the EAS; and
forwarding the first response message to the first device.
   Example 4: The method of any of the preceding examples, further comprising:
receiving a second message for a second device, via the first secure network tunnel, from the EAS; and
forwarding the second message to the second device.
   Example 5: The method of example 4, further comprising:
based on forwarding the second message, receiving a second response message for the EAS from the second device; and
forwarding the second response message to the EAS.
   Example 6: The method of example 4 or example 5, wherein the second device is in the first network segment, and wherein the first network segment is a Wi-Fi network segment or an Ethernet network segment.
   Example 7: The method of example 4, wherein the second device is in a third network segment of the fabric network, the method further comprising:
forwarding the second message to a border router in the first network segment that is effective to cause the border router to relay the second message to the second device in the third network segment.
   Example 8: The method of example 7, wherein the third network segment is a Thread network segment.
   Example 9: The method of any one of the preceding examples, wherein the EAS includes the second access router.
   Example 10: The method of any one of the preceding examples, wherein the first network route includes an Internet Protocol version 6 (IPv6) Unique Local Address (ULA) prefix for the fabric network, and a subnet identifier for the second network segment.
   Example 11: The method of any one of the preceding examples, wherein the establishing the first secure tunnel with the second access router comprises:
establishing the first secure tunnel with the second access router across an access network that is not included in the fabric network.
   Example 12: The method of example 11, wherein the access network comprises:
an IPv4 network; or
an IPv6 network.
   Example 13: The method of any one of the preceding examples, further comprising:
receiving a second advertisement for a fourth network segment of the fabric network;
establishing a second secure network tunnel with a third access router in the fourth network segment;
advertising, in the first network segment, a second network route to a Vendor Administrative Service, VAS, in the fourth network segment; and
using the advertised second network route, routing messages between one or more devices in the first network segment and the VAS.
   Example 14: The method of example 13, further comprising:
receiving a third message for the VAS from the first device in the first network segment; and
forwarding the third message, via the second secure tunnel, to the VAS in the fourth network segment.
   Example 15: The method of example 14, further comprising:
based on forwarding the third message, receiving a third response message for the first device from the VAS; and
forwarding the third response message to the first device.
   Example 16: The method of any one of examples 13 to 15, further comprising:
receiving a fourth message for the second device, via the second secure network tunnel, from the VAS; and
forwarding the fourth message to the second device.
   Example 17: The method of example 16, further comprising:
based on forwarding the fourth message, receiving a fourth response message for the VAS from the second device; and
forwarding the second response message to the VAS.
   Example 18: The method of example 16 or example 17, wherein the second device is in the first network segment, and wherein the first network segment is a Wi-Fi network segment or an Ethernet network segment.
   Example 19: The method of example 16, wherein the second device is in a third network segment, the method further comprising:
forwarding the fourth message to the border router in the first network segment that is effective to cause the border router to relay the fourth message to the second device in the third network segment.
   Example 20: The method of example 16, wherein the third network segment is a Thread network segment.
   Example 21: The method of any one of examples 13 to 20, wherein the second secure tunnel connects the second network segment and the fourth network segment, and wherein the second access router forwards communications between the third access router and the first access router.
   Example 22: The method of example 21, wherein the EAS includes the second access router.
   Example 23: The method of any one of examples 13 to 22, wherein the VAS includes the third access router.
   Example 24: The method of any one of examples 13 to 23, wherein the second network route includes an Internet Protocol version 6 (IPv6) Unique Local Address (ULA) prefix for the fabric network, and a subnet identifier for the third network segment.
   Example 25: The method of any one of examples 13 to 24, wherein the establishing the second secure tunnel with the third access router comprises:
establishing the second secure tunnel with the third access router across an access network that is not included in the fabric network.
   Example 26: The method of example 25, wherein the access network comprises:
an IPv4 network; or
an IPv6 network.
   Example 27: The method of any one of the preceding examples, wherein the fabric network is a Connected Home over IP (CHIP) network.
   Example 28: An access router device comprising:
a network interface;
a processor; and
memory comprising instructions executable by the processor that configure the network device to perform the method of any of the preceding examples.
   Example 29: The access router device of example 28, wherein the network interface comprises:
a Wi-Fi interface; or
an Ethernet interface.
   Example 30: A computer-readable storage media comprising instructions that, responsive to execution by a processor, cause a method as recited in any one of examples 1 to 27 to be performed.

Although aspects of administering network-connected devices using tunneled routing have been described in language specific to features and/or methods, the subject of the appended claims is not necessarily limited to the specific features or methods described. Rather, the specific features and methods are disclosed as example implementations of administering network-connected devices using tunneled routing, and other equivalent features and methods are intended to be within the scope of the appended claims. Further, various different aspects are described, and it is to be appreciated that each described aspect can be implemented independently or in connection with one or more other described aspects.

1. A method of accessing administrative services by a first access router in a first network segment of a fabric network, the method comprising:
receiving a first advertisement for a second network segment of the fabric network;
establishing a first secure network tunnel with a second access router in the second network segment;
advertising, in the first network segment, a first network route to an Ecosystem Administrative Service (EAS) in the second network segment; and
using the advertised first network route, routing messages between one or more devices in the first network segment and the EAS.

2. The method of claim 1, further comprising:
receiving a first message for the EAS from a first device in the first network segment; and
forwarding the first message, via the first secure tunnel to the EAS in the second network segment.

3. The method of claim 1, further comprising:
receiving a second message for a second device, via the first secure network tunnel, from the EAS; and
forwarding the second message to the second device.

4. The method of claim 3, wherein the second device is in the first network segment, and wherein the first network segment is a Wi-Fi network segment or an Ethernet network segment.

5. The method of claim 3, wherein the second device is in a third network segment of the fabric network, the method further comprising:
forwarding the second message to a border router in the first network segment that is effective to cause the border router to relay the second message to the second device in the third network segment.

6. The method of claim 5, wherein the third network segment is a Thread network segment.

7. The method of claim 1, wherein the EAS includes the second access router.

8. The method of claim 1, further comprising:
receiving a second advertisement for a fourth network segment of the fabric network;
establishing a second secure network tunnel with a third access router in the fourth network segment;
advertising, in the first network segment, a second network route to a Vendor Administrative Service VAS) in the fourth network segment; and
using the advertised second network route, routing messages between one or more devices in the first network segment and the VAS.

9. The method of claim 8, further comprising:
receiving a third message for the VAS from the first device in the first network segment; and
forwarding the third message, via the second secure tunnel, to the VAS in the fourth network segment.

10. The method of claim 8, further comprising:
receiving a fourth message for a second device, via the second secure network tunnel, from the VAS; and
forwarding the fourth message to the second device.

11. The method of claim 10, wherein the second device is in the first network segment, and wherein the first network segment is a Wi-Fi network segment or an Ethernet network segment.

12. The method of claim 10, wherein the second device is in a third network segment, the method further comprising:
forwarding the fourth message to a border router in the first network segment that is effective to cause the border router to relay the fourth message to the second device in the third network segment.

13. The method of claim 8, wherein the second secure tunnel connects the second network segment and the fourth network segment, and wherein the second access router forwards communications between the third access router and the first access router.

14. The method of claim 13, wherein the EAS includes the second access router.

15. An access router device comprising:
a network interface;
a processor; and
memory comprising instructions executable by the processor that configure the access router device to:
receive a first advertisement for a second network segment of a fabric network;
establish a first secure network tunnel with a second access router in the second network segment;
advertise, in a first network segment, a first network route to an Ecosystem Administrative Service (EAS) in the second network segment; and
using the advertised first network route, route messages between one or more devices in the first network segment and the EAS.

16. The access router device of claim 15, the instructions further executable to configure the access router device to:
receive a first message for the EAS from a first device in the first network segment; and
forward the first message, via the first secure tunnel to the EAS in the second network segment.

17. The access router device of claim 15, the instructions further executable to configure the access router device to:
receive a second message for a second device, via the first secure network tunnel, from the EAS; and
forward the second message to the second device.

18. The access router device of claim 17, wherein the second device is in the first network segment, and wherein the first network segment is a Wi-Fi network segment or an Ethernet network segment.

19. The access router device of claim 17, wherein the second device is in a third network segment of the fabric network, the instructions further executable to configure the access router device to:
forward the second message to a border router in the first network segment that is effective to cause the border router to relay the second message to the second device in the third network segment.

20. The access router device of claim 19, wherein the third network segment is a Thread network segment.
